(19) United States
(12) Patent Application Publication
(10) Pub. No.: US 2020/0406733 A1
(43) Pub. Date: Dec. 31, 2020

(54) MOVING BODY AND MOVING DEVICE

(71) Applicant: NIDEC CORPORATION, Kyoto (JP)

(72) Inventor: Atsushi YAMAMOTO, Kyoto (JP)

(21) Appl. No.: 16/767,592

(22) PCT Filed: Oct. 26, 2018
(86) PCT No.: PCT/JP2018/039924

§ 371 Date: May 28, 2020

(30) Foreign Application Priority Data
Dec. 5, 2017 (JP) 2017-233089

(51) Int. Cl. B60K 1/02; B60L 15/20; B60P 1/02; B66F 7/14

(52) U.S. Cl. CPC B60K 1/02; B66F 7/14; B60P 1/02; B60L 15/20

(57) ABSTRACT

The moving body includes: a vehicle body; a plurality of wheels supported by the vehicle body and configured to rotate; a plurality of motors configured to drive the wheels, respectively; and a rotating base supported by the vehicle body and configured to rotate about a substantially vertical axis.

### CROSS-REFERENCE TO RELATED APPLICATIONS

This is the U.S. national stage of application No. PCT/JP2018/039924, filed on Oct. 26, 2018, and priority under 35 U.S.C. § 119 (a) and 35 U.S.C. § 365(b) is claimed from Japanese Application No. 2017-233089, filed on Dec. 5, 2017.

### FIELD OF THE INVENTION

The present invention relates to a moving body and a moving device.

### BACKGROUND

Traveling bodies including a plurality of omni wheels capable of traveling in multiple directions are known.

However, omni wheels are expensive. In addition, the control of such omni wheels must be modified according to a shift of the center of gravity caused when a load is placed thereon, so that the control algorithms become complicated.

### SUMMARY

A moving body according to one exemplary aspect of the present invention includes: a vehicle body; a plurality of wheels supported by the vehicle body and configured to rotate; a plurality of motors configured to drive the wheels, respectively; and a rotating base supported by the vehicle body and configured to rotate about a substantially vertical axis.

A moving device according to another exemplary aspect of the present invention includes: a plurality of the above moving bodies; and a connecting carrier that is connected to the rotating base of each of the plurality of moving bodies.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view showing a moving body according to a first embodiment of the present invention;

FIG. 2 is a front view of a rotating base unit of the moving body according to the first embodiment;

FIG. 3 is a side view showing a moving device according to the first embodiment of the present invention;

FIG. 4 is a perspective view showing the moving device according to the first embodiment;

FIG. 5 is a block diagram of a control system including the moving body according to the first embodiment;

FIG. 6 is a sequence diagram showing an example of operation of controlling a plurality of motors in the control system according to the first embodiment;

FIG. 7 is a diagram showing an example of a control command transmitted from an external computer of the control system according to the first embodiment;

FIG. 8 is a sequence diagram showing an example of operation of measuring and reporting each condition in the control system according to the first embodiment;

FIG. 9 is a perspective view showing a moving body according to a second embodiment of the present invention; and

FIG. 10 is a front view of a rotating base unit and a lifting apparatus of the moving body according to the second embodiment.

### DETAILED DESCRIPTION

Embodiments of the present invention will be described below with reference to the accompanying drawings.

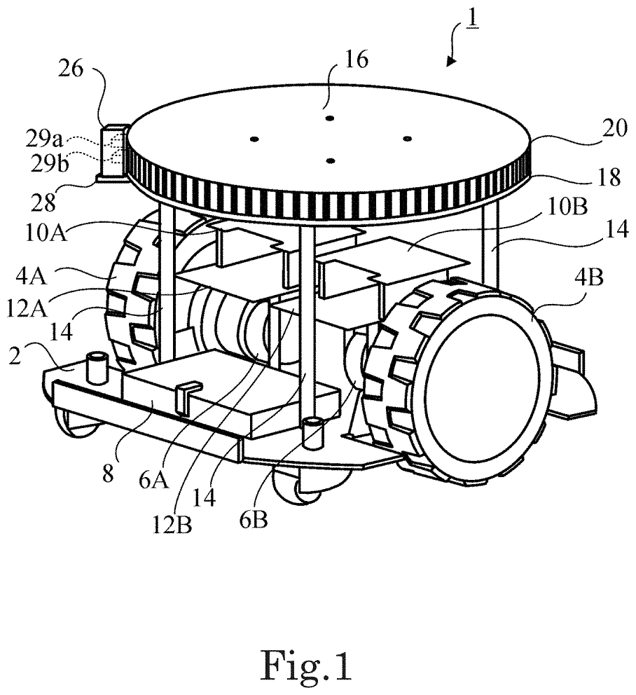

FIG. 1 is a perspective view showing a moving body 1 according to a first embodiment of the present invention. The moving body 1 includes a vehicle body (chassis) 2, and two wheels 4A, 4B supported by the vehicle body 2 and configured to rotate. The vehicle body 2 is a substantially horizontal frame provided at a lower portion of the moving body 1. The wheels 4A, 4B are of the same shape and size, and are arranged concentrically.

The vehicle body 2 includes two wheel motors 6A, 6B for respectively driving the wheels 4A, 4B mounted thereon. The vehicle body 2 also includes a battery case 8 mounted thereon that accommodates a battery that is a power supply for driving the wheel motors 6A, 6B. Further, the vehicle body 2 is equipped with printed boards 10A, 10B, 12A, 12B on which circuits for driving the wheel motors 6A, 6B are arranged.

Further, the vehicle body 2 is equipped with a plurality of columns 14, and the columns 14 support a rotating base unit 16. The rotating base unit 16 includes a support base 18 and a rotating base 20 having the same diameter. The support base 18 is fixed to the upper ends of the columns 14. The rotating base 20 is disposed above the support base 18 and concentrically with the support base 18.

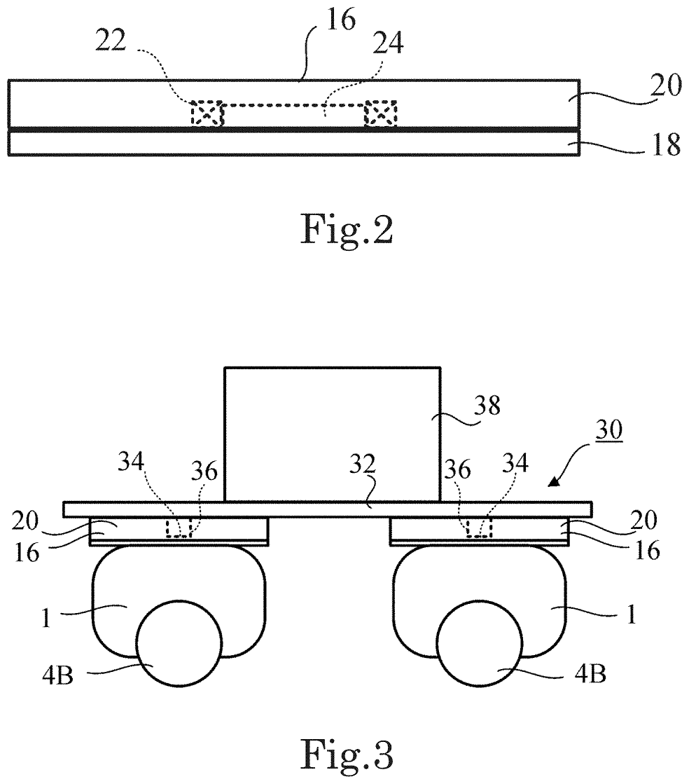

As shown in FIG. 2, the support base 18 is equipped with a bearing 22, and in the bearing 22, a rotating-base-metal-fitting 24 that is attached to the rotating base 20 is inserted. The bearing 22 may be attached to the rotating base 20, and the rotating-base-metal-fitting 24 may be attached to the support base 18 and inserted in the bearing 22. In either case, the rotating base 20 is rotatable with respect to the support base 18 about a substantially vertical axis.

The moving body 1 is provided with a measuring device for measuring the rotation angle of the rotating base 20 of the rotating base unit 16. The measuring device is not limited, but may be a photo sensor 26, for example. Specifically, the support base 18 is equipped with a bracket 28, and the bracket 28 supports the photo sensor 26, as shown in FIG. 1. The photo sensor 26 has two photo reflectors 29a, 29b, for example.

The outer circumferential surface of the rotating base 20 has a plurality of white portions and a plurality of black portions that are provided in an alternate manner. The plurality of white portions are arranged at equal angular intervals, and the plurality of black portions are also arranged at equal angular intervals. The white portions and the black portions may be provided by coloring, or may be provided by attaching pieces of white tape and black tape to the rotating base 20.

Each of the photo reflectors 29a, 29b has a light-emitting element (e.g., a light-emitting diode) and a light-receiving element (e.g., a phototransistor), and the light-receiving element receives the light that has been emitted from the light-emitting element and reflected on the outer circumferential surface of the rotating base 20. The light-receiving element outputs an electric signal corresponding to the intensity of the received light. The level of the electric signal output from the light-receiving element varies depending on whether the light-receiving element faces the white portion or the black portion. Therefore, the rotation angle of the rotating base 20 can be measured by grasping the number of times the level of the electric signal has changed since the rotating base 20 has been positioned at a reference angle.

In the present embodiment, the two photo reflectors 29a, 29b have different angular positions with respect to the rotating base 20. Since the different angular positions cause a difference in the output phases of the two photo reflectors 29a, 29b, which makes it possible to determine the rotation direction of the rotating base 20.

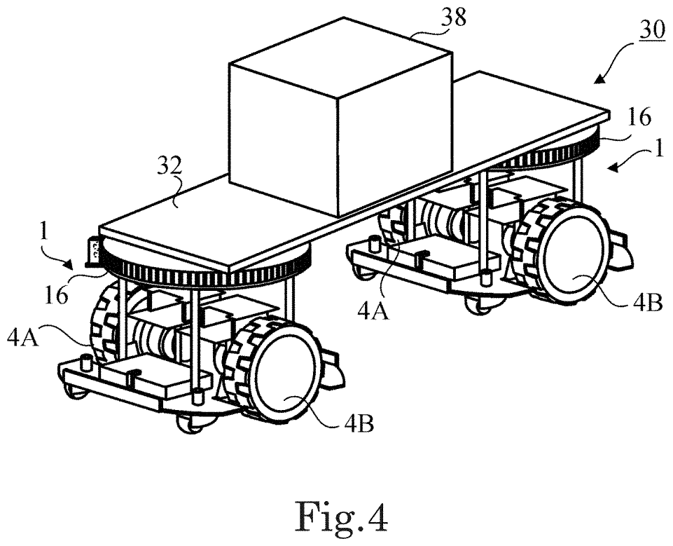

FIGS. 3 and 4 show a moving device 30 according to the first embodiment. The moving device 30 includes a connecting carrier 32 that joins the rotating bases 20 of the rotating base units 16 of the two moving bodies 1.

Specifically, a groove or a recess 34 is formed at the center of each rotating base 20, and two protrusions 36 are formed or attached to the lower surface of the connecting carrier 32. Each of the protrusions 36 is fitted into the recess 34. The connecting carrier 32 does not rotate with respect to the rotating base 20 of each of the moving bodies 1.

The connecting carrier 32 has a flat upper surface, and can carry a load 38 on the upper surface.

The moving body 1 alone can also carry the load 38. In this case, the load 38 is placed on the rotating base 20 of the rotating base unit 16 without using the connecting carrier 32.

However, the moving device 30 formed by joining a plurality of moving bodies 1 with the connecting carrier 32 can carry a heavy load 38. In this case, the rotating bases 20 of the rotating base units 16 of the plurality of moving bodies 1 connected by the connecting carrier 32 rotate according to the respective travelling directions of the moving bodies 1, which does not hamper travelling of the moving bodies 1.

In the moving device 30 shown in the figures, two moving bodies 1 are joined together, but three or more moving bodies 1 may be joined together by connecting the rotating bases 20 of their rotating base units 16 with one another.

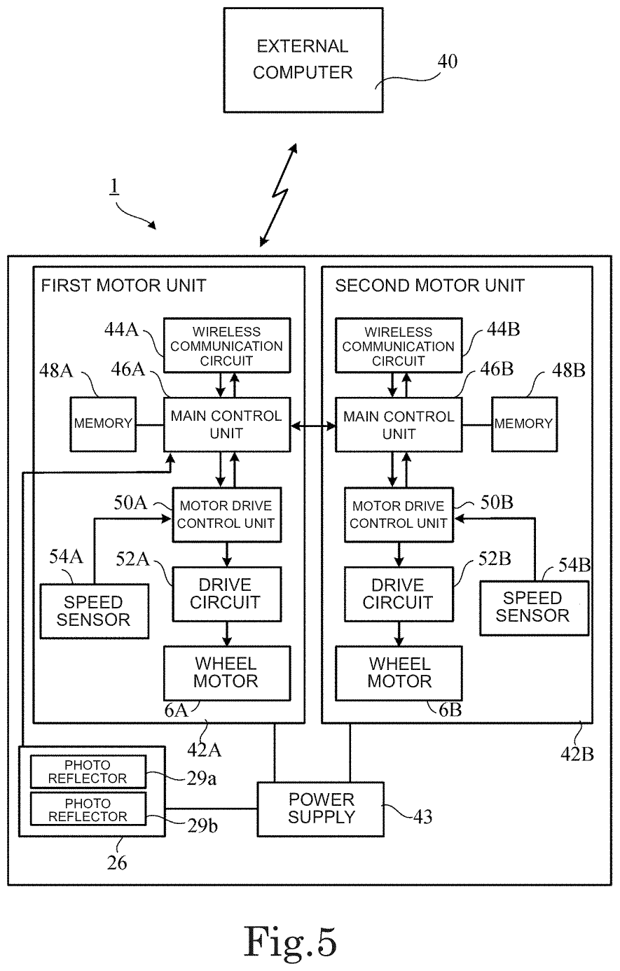

FIG. 5 is a block diagram of a control system including the moving body 1 according to the first embodiment of the present invention. The moving body 1 can wirelessly communicate with an external computer 40 that remotely operates the moving body 1. The wireless communication method is not limited, but Wi-Fi (registered trademark) may be employed, for example.

The moving body 1 includes two motor units, that is, a first motor unit 42A and a second motor unit 42B. The motor units 42A, 42B respectively correspond to the wheel motors 6A, 6B.

The motor units 42A, 42B are powered by a power supply 43. The power supply 43 is a battery accommodated in the battery case 8 (see FIG. 1). The photo sensor 26 is also powered by the power supply 43.

The first motor unit 42A includes the wheel motor 6A, a wireless communication circuit 44A, a main control unit 46A, a memory 48A, a motor drive control unit 50A, a drive circuit 52A, and a speed sensor 54A. The second motor unit 42B includes the wheel motor 6B, a wireless communication circuit 44B, a main control unit 46B, a memory 48B, a motor drive control unit 50B, a drive circuit 52B, and a speed sensor 54B. Hereinafter, the wheel motor 6A may be referred to as a first wheel motor 6A, and the wheel motor 6B may be referred to as a second wheel motor 6B.

The wireless communication circuit 44A, the main control unit 46A, the memory 48A, and the motor drive control unit 50A are mounted on the printed board 12A (see FIG. 1) as a main control circuit. The drive circuit 52A includes an inverter and a motor driver, and is mounted on the printed board 10A (see FIG. 1). The wireless communication circuit 44B, the main control unit 46B, the memory 48B, and the motor drive control unit 50B are mounted on the printed board 12B (see FIG. 1) as a main control circuit. The drive circuit 52B includes an inverter and a motor driver, and is mounted on the printed board 10B (see FIG. 1).

The wireless communication circuits 44A, 44B are configured to wirelessly communicate with the external computer 40. However, in the present embodiment, only the wireless communication circuit 44A of the first motor unit 42A is normally used. The wireless communication circuit 44B of the second motor unit 42B can be used as a backup in case of a failure of the wireless communication circuit 44A.

Each of the main control units 46A, 46B is a processor, and operates by reading and implementing a program stored in a recording medium (not shown). Therefore, the program (program code) itself read from the recording medium implements the function of the embodiment. Further, the recording medium storing the program can constitute the present invention.

The main control unit 46A wirelessly communicates with the external computer 40 using the wireless communication circuit 44A. The main control unit 46A controls the motor drive control unit 50A to control driving of the wheel motor 6A. Further, the main control unit 46A is communicably wired to the main control unit 46B of the second motor unit 42B.

The main control unit 46B controls the motor drive control unit 50B to control driving of the wheel motor 6B. Further, the main control unit 46B can wirelessly communicate with the external computer 40 using the wireless communication circuit 44B as necessary.

The memories 48A, 48B are configured to store data necessary for the respective main control units 46A, 46B to perform processing. The main control units 46A, 46B are configured to read necessary data from the respective memories 48A, 48B. The memories 48A, 48B are volatile memories, but may be nonvolatile memories. Further, each of the memories 48A, 48B may include both a volatile memory and a nonvolatile memory.

The motor drive control unit 50A is configured to control driving (for example, the rotational speed) of the wheel motor 6A according to a command from the main control unit 46A. The motor drive control unit 50B is configured to control driving (for example, the rotational speed) of the wheel motor 6B according to a command from the main control unit 46B. Each of the motor drive control units 50A, 50B, for example, can perform proportional-integral-differential (PID) control or vector control, for example, and is formed of a microprocessor, an application specific integrated circuit (ASIC), or a digital signal processor (DSP), for example.

The drive circuit 52A is configured to drive the wheel motor 6A under the control of the motor drive control unit 50A. The drive circuit 52B is configured to drive the wheel motor 6B under the control of the motor drive control unit 50B.

The speed sensors 54A, 54B are configured to output electric signals indicating the rotational speeds of the wheel motors 6A, 6B, respectively. The speed sensors 54A, 54B are, for example, Hall sensors that are mounted inside the wheel motors 6A, 6B, respectively, and are configured to convert a magnetic field into an electric signal. The motor drive control unit 50A determines the rotational speed of the wheel motor 6A based on the output signal of the speed sensor 54A. That is, the motor drive control unit 50A measures the rotational speed of the wheel motor 6A. The motor drive control unit 50B determines the rotational speed of the wheel motor 6B based on the output signal of the speed sensor 54B. That is, the motor drive control unit 50B measures the rotational speed of the wheel motor 6B. The measured value of the rotational speed of the wheel motor 6A is notified to the main control unit 46A, and the main control unit 46A uses the value of the rotational speed of the wheel motor 6A to provide a command for controlling driving of the wheel motor 6A to the motor drive control unit 50A. The measured value of the rotational speed of the wheel motor 6B is notified to the main control unit 46B and the main control unit 46B uses the value of the rotational speed of the wheel motor 6B to provide a command for controlling driving of the wheel motor 6B to the motor drive control unit 50B.

Further, the motor drive control unit 50A calculates the torque of the wheel motor 6A with a publicly known calculation method based on the current value of the drive circuit 52A. That is, the motor drive control unit 50A measures the torque of the wheel motor 6A. The motor drive control unit 50B calculates the torque of the wheel motor 6B with a publicly known calculation method based on the current value of the drive circuit 52B. That is, the motor drive control unit 50B measures the torque of the wheel motor 6B. The measured value of the torque of the wheel motor 6A is notified to the main control unit 46A, and the main control unit 46A uses the value of the torque of the wheel motor 6A to provide a command for controlling driving of the wheel motor 6A to the motor drive control unit 50A. The measured value of the torque of the wheel motor 6B is notified to the main control unit 46B, and the main control unit 46B uses the value of the torque of the wheel motor 6B to provide a command for controlling driving of the wheel motor 6B to the motor drive control unit 50B.

The output signals of the two photo reflectors 29a, 29b of the photo sensor 26 are supplied to the main control unit 46A of the first motor unit 42A. According to the above configuration, the main control unit 46A determines the rotation direction of the rotating base 20 and also the rotation angle of the rotating base 20 based on the output signals of the photo reflectors 29a, 29b. That is, the main control unit 46A measures the rotation angle of the rotating base 20.

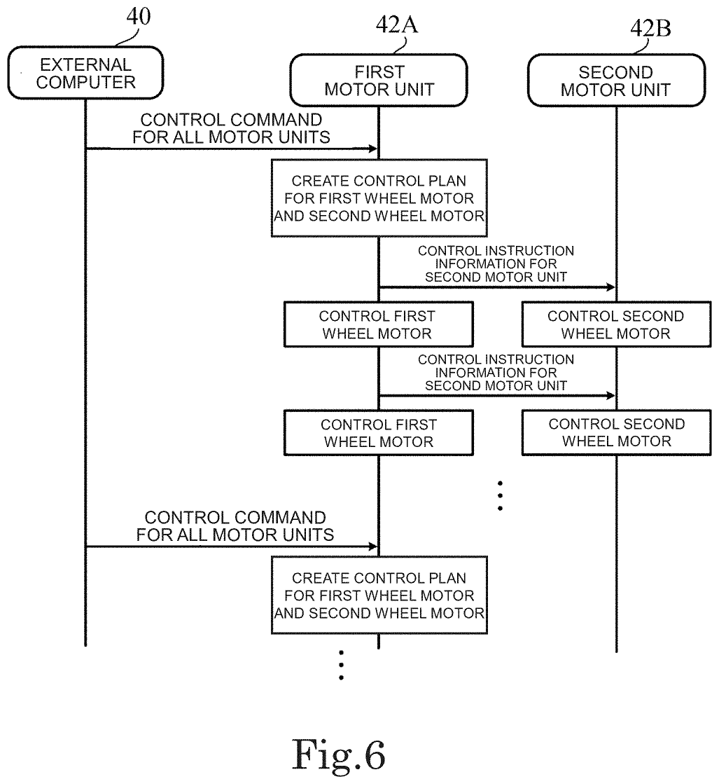

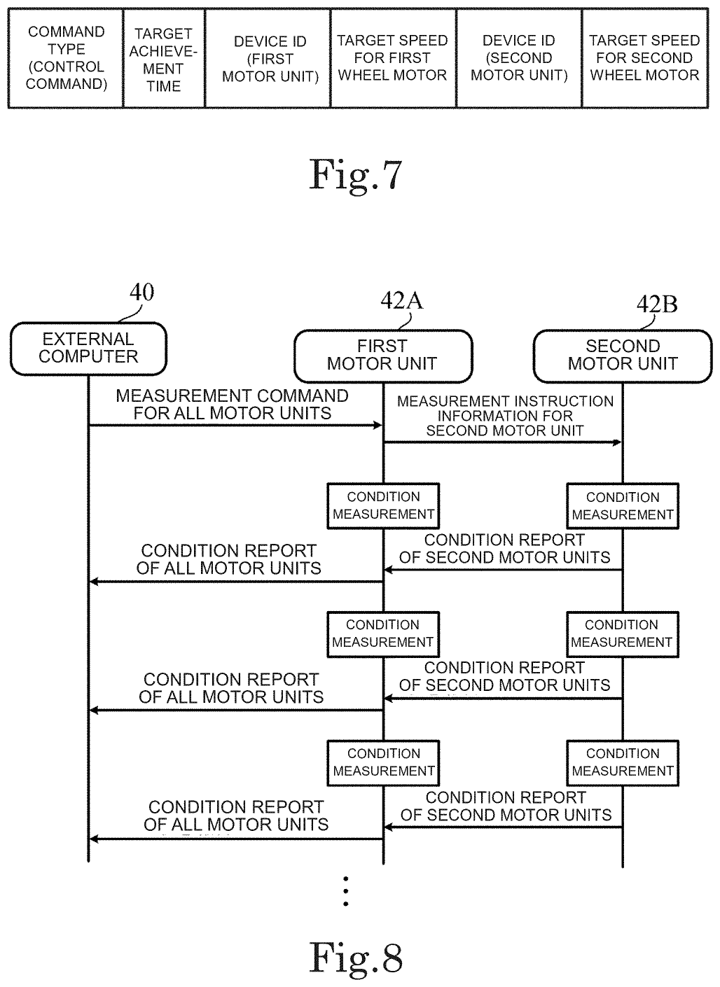

With reference to FIGS. 6 and 7, the description will be given of an example of operation of controlling the wheel motors 6A, 6B of the motor units 42A, 42B performed based on a control command from the external computer 40. This operation is individually performed for each moving body 1 in the moving device 30 including a plurality of moving bodies 1 (see FIGS. 3 and 4).

As shown in FIG. 6, the external computer 40 transmits a control command for all the motor units 42A, 42B to the first motor unit 42A by wireless communication. The control command for all the motor units 42A, 42B is a control command for controlling driving of both the wheel motors 6A, 6B. In the first motor unit 42A, when the wireless communication circuit 44A receives the control command, the main control unit 46A stores the received control command in the memory 48A.

As shown in FIG. 7, a format of the control command includes, for example, a field indicating a command type, a field indicating a target achievement time, and a field indicating a first device ID (a device ID for the first motor unit 42A), a field indicating a target speed for the first wheel motor 6A, a field indicating a second device ID (a device ID for the second motor unit 42B), and a field indicating a target speed for the second wheel motor 6B. The field indicating a command type includes a bit string indicating that the transmitted command is a control command for setting a target speed. The field indicating a target achievement time includes a bit string indicating a time period until the wheel motors 6A, 6B reach a target speed after the control command is received. The field indicating a device ID includes a bit string indicating an ID for the motor unit having the wheel motor to be controlled by the control command. That is, the two fields indicating the device IDs each include a bit string indicating the device ID for the first motor unit 42A or a bit string indicating the device ID for the second motor unit 42B. The field indicating a target speed immediately after the field indicating the device ID of the first motor unit 42A includes a bit string indicating a target speed for the first wheel motor 6A. The field indicating a target speed immediately after the field indicating the device ID of the second motor unit 42B includes a bit string indicating a target speed for the second wheel motor 6B.

It is assumed that, for example, this control command specifies 100 ms as the target achievement time, 100 rpm as the target speed for the first wheel motor 6A, and 200 rpm as the target speed for the second wheel motor 6B. In this case, according to the control command, the first motor unit 42A should adjust the rotational speed of the wheel motor 6A to reach 100 rpm, and the second motor unit 42B should adjust the rotational speed of the wheel motor 6B to reach 200 rpm in 100 ms after the control command is received.

Referring back to FIG. 6, in the first motor unit 42A, the main control unit 46A creates a control plan for the first wheel motor 6A and the second wheel motor 6B. Specifically, the main control unit 46A determines instantaneous target speeds for the first wheel motor 6A and the second wheel motor 6B for each moment until the target achievement time has elapsed. Each of the moments is separated from one another by a constant control cycle.

The determination may be made by interpolation based on the current rotational speed of each motor, the target speed for each motor specified in the control command, and the target achievement time specified in the control command. For example, in the case where the wheel motors 6A, 6B are stopped (in the case where the rotational speeds are 0 rpm) when the control command of the above assumed example is received, the main control unit 46A determines the instantaneous target speed for the first wheel motor 6A for each moment of every 1 ms so as to increase the rotational speed of the first wheel motor 6A by 1 rpm for each moment of every 1 ms. Further, the main control unit 46A determines the instantaneous target speed for the second wheel motor 6B for each moment of every 1 ms so as to increase the rotational speed of the second wheel motor 6B by 2 rpm for each moment of every 1 ms. Thus, after a lapse of 100 ms, the rotational speed of the wheel motor 6A reaches 100 rpm, and the rotational speed of the wheel motor 6B reaches 200 rpm. In this example, the main control unit 46A uses linear interpolation in determining the instantaneous target speeds for the wheel motors 6A, 6B, but may use another interpolation algorithm.

Once determining the instantaneous target speeds for the wheel motors 6A, 6B as described above, the main control unit 46A stores the instantaneous target speeds for the wheel motors 6A, 6B in the memory 48A.

Thereafter, the main control unit 46A controls the motor drive control unit 50A to adjust the rotational speed of the first wheel motor 6A according to the control plan. That is, the main control unit 46A reads the instantaneous target speed for the first wheel motor 6A from the memory 48A at each moment, and repeats, in a constant control cycle (for example, every 1 ms), controlling of the motor drive control unit 50A so that the rotational speed of the first wheel motor 6A reaches the instantaneous target speed. Further, the main control unit 46A transmits control instruction information on control of driving of the second wheel motor 6B to the second motor unit 42B by wired communication according to the control plan. That is, the main control unit 46A reads the instantaneous target speed of the second wheel motor 6B from the memory 48A at each moment, and repeats, in a constant control cycle (for example, every 1 ms), transmitting of the control instruction information indicating the instantaneous target speed of the second wheel motor 6B to the second motor unit 42B by wired communication.

In the second motor unit 42B, the main control unit 46B repeatedly receives the control instruction information indicating the instantaneous target speed for the second wheel motor 6B from the first motor unit 42A in a constant control cycle (for example, every 1 ms). Every time the main control unit 46B receives the control instruction information, the main control unit 46B controls the motor drive control unit 50B according to the control instruction information so that the rotational speed of the second wheel motor 6B reaches the instantaneous target speed.

In the first motor unit 42A, when the wireless communication circuit 44A receives a new control command, the main control unit 46A creates a new control plan for the first wheel motor 6A and the second wheel motor 6B based on the current rotational speed of each motor, the target speed for each motor specified in the new control command, and the target achievement time specified in the new control command. The creation of the new control plan is implemented even when the current rotational speed of each motor has not reached the target speed specified in the immediately preceding control command.

Thereafter, the main control unit 46A controls the motor drive control unit 50A to adjust the rotational speed of the first wheel motor 6A according to the new control plan, and transmits the control instruction information on control of driving of the second wheel motor 6B to the second motor unit 42B by wired communication according to the new control plan. In this way, the rotational speeds of the wheel motors 6A, 6B are synchronized and adjusted repeatedly.

In the above example, the control cycle of each motor is 1 ms, but is not limited to 1 ms and may be 5 ms, for example.

Alternatively, the main control unit 46A of the first motor unit 42A may determine the instantaneous target speed for the first wheel motor 6A with a short control cycle (for example, every 1 ms), and may determine the instantaneous target speed for the second wheel motor 6B with a long control cycle (for example, every 5 ms). In this case, the main control unit 46A transmits control instruction information specifying the instantaneous target speed for the second wheel motor 6B for the long control cycle (for example, every 5 ms) to the second motor unit 42B by wired communication in the long control cycle. The second motor unit 42B determines the instantaneous target speed for the wheel motor 6B for the short control cycle on the basis of the current rotational speed of the wheel motor 6B, the instantaneous target speed specified in the control instruction information, and the long control cycle. The determination of the instantaneous target speed for the short control cycle may be performed by interpolation, for example, linear interpolation. The main control unit 46A of the first motor unit 42A controls the motor drive control unit 50A and adjusts the rotational speed of the first wheel motor 6A according to the instantaneous target speed for the first wheel motor 6A for the short control cycle calculated by the main control unit 46A. The main control unit 46B of the second motor unit 42B controls the motor drive control unit 50B and adjusts the rotational speed of the second wheel motor 6B according to the instantaneous target speed for the second wheel motor 6B for the short control cycle calculated by the main control unit 46B. In this way, the rotational speeds of the wheel motors 6A, 6B are synchronized and adjusted repeatedly. In this case, even when the control instruction information cannot be transmitted from the first motor unit 42A to the second motor unit 42B in the short control cycle, the rotational speed of the wheel motor 6B can be adjusted in the short control cycle.

With reference to FIG. 8, the description now turns to an example of operation of measuring and reporting each condition of the motor units 42A, 42B performed by the motor units 42A, 42B. This operation is individually performed for each moving body 1 in the moving device 30 including a plurality of moving bodies 1 (see FIGS. 3 and 4).

As shown in FIG. 8, the external computer 40 transmits a measurement command for all the motor units 42A, 42B to the first motor unit 42A by wireless communication. The measurement command for all the motor units 42A, 42B is a command instructing to measure the current rotational speed and the current torque of the first wheel motor 6A of the first motor unit 42A, the current rotational speed and the current torque of the second wheel motor 6B of the second motor unit 42B, and the current rotation angle of the rotating base 20 and to report the measured results. The measurement command includes an identifier indicating that the command is a measurement command, a measurement start timing, and a report cycle (measurement cycle).

In the first motor unit 42A, when the wireless communication circuit 44A receives the measurement command from the external computer 40, the main control unit 46A stores the measurement command in the memory 48A. Further, the main control unit 46A transmits measurement instruction information for the second motor unit 42B to the second motor unit 42B by wired communication. The measurement instruction information indicates a measurement start timing and a report cycle specified in the measurement command. In the second motor unit 42B, when the main control unit 46B receives the measurement instruction information from the first motor unit 42A by wired communication, the main control unit 46B stores the measurement instruction information in the memory 48B.

The main control unit 46A performs a condition measurement operation at the measurement start timing specified in the measurement command. Specifically, the main control unit 46A causes the motor drive control unit 50A to measure the rotational speed and the torque of the first wheel motor 6A, and receives the measured values of the rotational speed and the torque from the motor drive control unit 50A. Further, the main control unit 46A measures the rotation angle of the rotating base 20.

Further, the main control unit 46B performs the condition measurement operation at the measurement start timing indicated by the measurement instruction information. Specifically, the main control unit 46B causes the motor drive control unit 50B to measure the rotational speed and the torque of the second wheel motor 6B, and receives the measured values of the rotational speed and the torque from the motor drive control unit 50B. After completion of the measurement operation, the main control unit 46B transmits a report indicating the measurement result to the first motor unit 42A by wired communication as a condition report of the second motor unit 42B.

Upon receiving the condition report of the second motor unit 42B, the main control unit 46A of the first motor unit 42A collectively transmits the condition report on all the motor units 42A, 42B indicating the measurement result by the main control unit 46A and the measurement result by the main control unit 46B to the external computer 40 by wireless communication.

Thereafter, in the reporting cycle (measurement cycle) specified in the measurement command, the main control unit 46A of the first motor unit 42A performs the condition measurement operation, and the main control unit 46B of the second motor unit 42B performs the condition measurement operation. Then, the second motor unit 42B transmits the condition report of the second motor unit 42B to the first motor unit 42A by wired communication, and the first motor unit 42A collectively transmits the condition report of all the motor units 42A, 42B to the external computer 40 by wireless communication.

In this embodiment, the rotation angle of the rotating base 20 of the moving body 1 can be adjusted according to the orientation of the load. Thus, the orientation of the load can be adjusted without the need for omni wheels which are expensive and tend to cause a skid. This achieves easy and accurate control of the traveling direction of the moving body 1 using inexpensive wheels 4A, 4B.

In particular, in the moving device 30 in which the rotating base units 16 of the plurality of moving bodies 1 are connected by the connecting carrier 32, the rotating base units 16 of the plurality of moving bodies 1 connected by the connecting carrier 32 rotate according to the respective travelling directions of the moving bodies 1, and thus travelling of each of the moving bodies 1 is not hampered. That is, each of the plurality of moving bodies 1 can travel smoothly under the control of the external computer 40, even when they are connected with each other.

Each of the moving bodies 1 is provided with a measuring device, such as the photo sensor 26, configured to measure the rotation angle of the rotating base 20. This enables each moving body 1 to report the rotation angle of the rotating base 20 to the external computer 40 which is an external control device. The external computer 40 can determine the rotational speeds of the wheel motors 6A and 6B of each moving body 1 in consideration of the orientation of the load 38 on the connecting carrier 32 connecting the plurality of moving bodies 1. This makes it possible to appropriately adjust the orientation of the load 38.

The rotational speeds of the wheel motors 6A, 6B may be adjusted by each moving body 1 itself on the basis of the rotation angle of the rotating base 20 measured by the measuring device. For example, in the operation of controlling the wheel motors 6A, 6B described above with reference to FIG. 7, the main control unit 46A may create a control plan for the first wheel motor 6A and the second wheel motor 6B in consideration of the rotation angle of the rotating base 20. This makes it possible to appropriately adjust the orientation of the load 38.

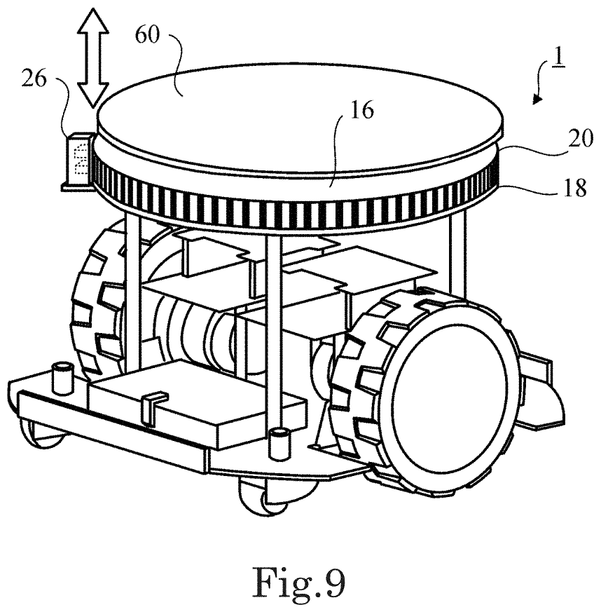

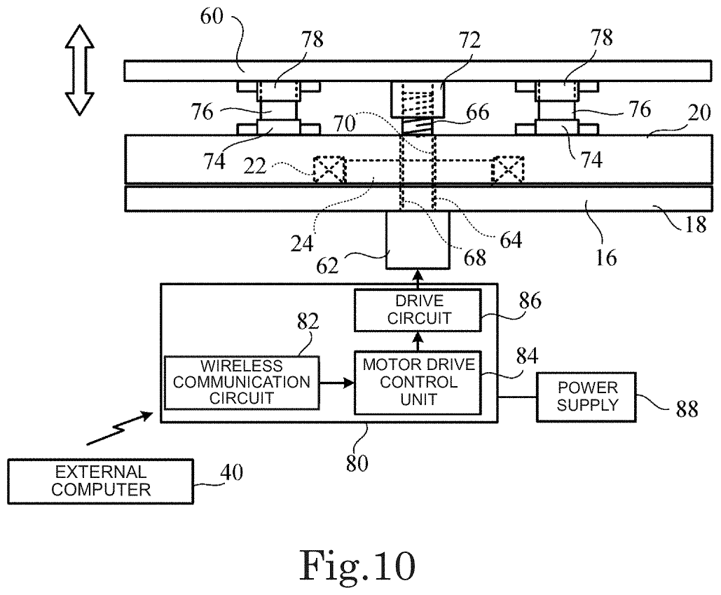

A moving body 1 according to a second embodiment of the present invention will be described with reference to FIGS. 9 and 10. The moving body 1 according to the second embodiment further includes: a carrier 60 configured to move up and down; and a drive mechanism configured to lift and lower the carrier 60. Other features of the second embodiment are the same as those of the first embodiment, and the same reference numerals as those of the first embodiment are used in the drawings to indicate constituent elements common to the first embodiment.

The carrier 60 is a flat circular plate. The carrier 60 is disposed above the rotating base unit 16 concentrically with the rotating base unit 16.

As shown in FIG. 10, a motor 62 configured to lift and lower the carrier 60 is provided below the support base 18 of the rotating base unit 16. The motor 62 has a rotating shaft 64 that is arranged vertically. The rotating shaft 64 includes a lead screw 66. The rotating shaft 64 is inserted into a through hole 68 disposed at the center of the support base 18 and into a through hole 70 disposed at the center of the rotating base 20.

A nut 72 is fixed to the lower surface of the carrier 60. The nut 72 is engaged with the lead screw 66 of the rotating shaft 64 of the motor 62.

The rotating base 20 of the rotating base unit 16 includes a plurality of (preferably three or more) brackets 74 fixed thereto. The brackets 74 respectively support guide shafts 76. The lower surface of the carrier 60 includes a plurality of brackets 78 fixed thereto. The tips of the guide shafts 76 are held by the brackets 78, respectively.

In the above configuration, when the rotation shaft 64 of the motor 62 rotates, the nut 72 moves upward or downward due to the lead screw 66, so that the carrier 60 moves upward or downward. The plurality of guide shafts 76 hold the carrier 60 horizontally.

The motor 62 is driven by a motor drive unit 80. The motor drive unit 80 includes a wireless communication circuit 82, a motor drive control unit 84, and a drive circuit 86. The wireless communication circuit 82 is configured to receive a control command from the external computer 40 by wireless communication. The wireless communication may be achieved by, for example, Wi-Fi, or any other techniques. The motor drive control unit 84 controls driving of the motor 62 in accordance with the control command received by the wireless communication circuit 82. The motor drive control unit 84 is, for example, a microprocessor, an ASIC, or a DSP.

The motor drive unit 80 is powered by a power supply 88. The power supply 88 is a separate battery from the power supply 43, and can be fixed onto the rotating base 20, for example. However, the motor drive unit 80 may be powered by the above-described power supply 43 (see FIG. 5).

According to the present embodiment, it is possible to adjust the carrier 60 to a desired height and smoothly deliver a load. For example, when the carrier 60 is to carry a load, the operator of the external computer 40 can cause the external computer 40 to give a command to the motor drive unit 80 to correspond the height of the carrier 60 with that of the platform, pallet, or conveyor on which the load is placed. When the load is to be unloaded from the carrier 60, the operator of the external computer 40 can cause the external computer 40 to give a command to the motor drive unit 80 to correspond the height of the carrier 60 with that of the platform, pallet, or conveyor on which the load is to be placed.

A plurality of the moving bodies 1 according to the present embodiment can be joined together by the technique illustrated in FIGS. 3 and 4. In this case, the recesses 34 for fitting the protrusions 36 of the connecting carrier 32 (see FIG. 3) are provided with the carrier 60. In this case, the rotating bases 20 of the rotating base units 16 of the plurality of moving bodies 1 connected by the connecting carrier 32 rotate according to the respective travelling directions of the moving bodies 1, which does not hamper travelling of the moving bodies 1.

Although the embodiments of the present invention have been described above, the above description should not limit the present invention, and various modifications including deletion, addition, and replacement of components can be considered to fall within the technical scope of the present invention.

For example, each moving body 1 includes two wheels 4A, 4B, and two wheel motors 6A, 6B according to the above embodiments. However, each moving body 1 may include three or more wheels, and three or more motor units for driving the three or more wheels.

The drive mechanism for lifting and lowering the carrier 60 of the second embodiment uses the lead screw 66 and the nut 72, but other drive mechanisms such as a rack and pinion may be used.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A moving body comprising:
a vehicle body;
a plurality of wheels supported by the vehicle body and configured to rotate;
a plurality of motors configured to drive the wheels, respectively; and
a rotating base supported by the vehicle body and configured to rotate about a substantially vertical axis.

2. The moving body according to claim 1, further comprising a measuring device configured to measure a rotation angle of the rotating base.

3. The moving body according to claim 2, further comprising a control unit configured to control the plurality of motors,
wherein the control unit adjusts speeds of the plurality of motors based on the rotation angle of the rotating base measured by the measuring device.

4. The moving body according to claim 1, further comprising:
a carrier that is disposed above the rotating base and is configured to move up and down; and
a drive mechanism configured to lift and lower the carrier.

5. A moving device comprising:
a plurality of the moving bodies according to claim 1; and
a connecting carrier that is connected to the rotating base of each of the plurality of moving bodies.
